(19) United States
(12) Patent Application Publication
(10) Pub. No.: US 2022/0008974 A1
(43) Pub. Date: Jan. 13, 2022

(54) Dry Coated Zero Valent Iron (ZVI) Material for Environmental Remediation of Dissolved Phase and Dense Non-Aqueous Phase Liquid (DNAPL) Chlorinated Solvents

(71) Applicant: Innovative Environmental Technologies, Inc, Pipersville, PA (US)

(72) Inventor: Michael Scalzi, Doylestown, PA (US)

(21) Appl. No.: 17/386,507

(22) Filed: Jul. 27, 2021

Related U.S. Application Data
(63) Continuation-in-part of application No. 16/167,445, filed on Oct. 22, 2018, now abandoned.
(60) Provisional application No. 62/575,161, filed on Oct. 20, 2017.

(51) Int. Cl. B09C 1/08; B09C 1/00; B01J 20/02; B01J 20/32

(52) U.S. Cl. CPC B09C 1/08; B09C 1/002; B09C 2101/00; B01J 20/3293; B01J 20/0229

(57) ABSTRACT

A dry-coated zero valent iron (ZVI) based material that provides for treatment of dissolved phase chlorinated solvents and the Dense-Non-Aqueous-Phase Liquids (DNAPLs) of these solvents when present as pure solvent in groundwater systems when mixed as a slurry with water. The ZVI particles are individually coated with a hydrophobic, oleophilic vegetable oil or similar material. The coated ZVI particles, when emplaced in groundwater systems provides for rapid adsorption of both dissolved phase and DNAPLs into the oleophilic coating, promoting direct contact with the ZVI surface, providing for an abiotic surface reduction of the chlorinated solvents by the ZVI. The coating protects the reactive surfaces of the ZVI from passivation and oxidation during both preparation of the slurry and delivery of the slurry to the subsurface. The dry-coated ZVI product further includes dispersing and thickening agents that allow for mixing and delivery of the dry-coated ZVI product to the subsurface.

### BACKGROUND

Chlorinated solvents are some of the most frequently occurring types of contaminants in soil and groundwater at designated Superfund and other hazardous waste sites in the United States. They are organic compounds that contain chlorine atoms, and their properties make them ideal for many industrial-cleaning applications such as degreasing oils and fats. Common solvents include tetrachloroethene (PCE) and trichloroethene (TCE), used extensively in the dry-cleaning industry, and 1,1,1-trichloroethane (TCA) and Methylene Chloride typically used as industrial degreasers. Many of these chlorinated solvents are hydrophobic, thus they tend to partition to the soil matrix rather than be readily available in the aqueous phase in groundwater systems impacted by chlorinated solvents. Further, when present in high concentrations in groundwater, the chlorinated solvents form a dense non-aqueous phase liquid (DNAPL). A DNAPL is a liquid that is both denser than water and is immiscible in or does not dissolve in water and is used to describe free-phase contaminants in groundwater, surface water and sediments.

Zero valent iron (ZVI), elemental metallic iron, has the ability to reduce waterborne inorganic ions by releasing soluble Fe(II) particles that further oxidize into Fe(III). In general, ZVI describes the elemental form of iron, and refers to the zero-charge carried by each atom, a result of the outer valence level being filled. These characteristics allow ZVI to convert oxidized elements, which may be toxic and soluble in water, into immobile solid forms. ZVI can effectively reduce contaminants such as heavy metals, chlorinated solvents, and petroleum aromatic hydrocarbons.

Initially, permeable reactive barriers (PRB) were constructed downstream from groundwater plumes and filled with ZVI in order to intercept and dechlorinate chlorinated hydrocarbons with the groundwater plume as the plume passes through the PRB. Currently, ZVI in both the micro and macro-scale is used in PRBs. Later, it was realized that micro-scale ZVI could be mixed with other materials to create a slurry and the slurry could be provided to the subsurface where the contaminants are located via injection rods, wells or the like.

The efficacy of the ZVI is directly affected by ability of the ZVI surface to be exposed to the targeted chlorinated solvents. The ZVI available to be exposed to the contaminants is impacted by the oxidation and passivation of the ZVI by water and oxygen respectively. The reactive surfaces of the iron are reduced via from passivation and oxidation during both preparation of the slurry and delivery of the slurry to the subsurface. The challenges of preserving and maintaining the integrity of the ZVI during shipping, mixing and delivery to the subsurface have been addressed through various methods as the technology has become more accepted and applied by the environmental remediation market. For example, ZVI has been packages in liquid vegetable oils and mixed with oxygen scavenges during the delivery preparation processes.

ZVI based remediation approaches for targeting DNAPLs have incorporated the metal particles in micelles within reverse emulsions. The production of these reverse emulsions requires sophisticated high sheer mixing equipment to generate a stable emulsion. These liquid remediation amendments referred to as emulsified zero valent iron (EZVI) may consist of up to ten percent (10%) ZVI and over fifty percent (50%) water. These EZVI materials have been applied specifically to DNAPLs because their specific gravities mimic that of free phase chlorinated solvents. These emulsions have little capability in more dilute chlorinated solvent impacted groundwaters.

What is needed is a ZVI that provides protection against passivation and oxidation during both preparation and delivery, does not require the complex mixing required of EZVI, and can be utilized for both DNAPLs and dissolved phase chlorinated solvents. Furthermore, a ZVI that can be mixed into a slurry on site in preparation for

### BRIEF DESCRIPTION OF THE DRAWINGS

The features and advantages of the various embodiments will become apparent from the following detailed description in which:

FIG. 1 illustrates an example phospholipid utilized for forming a lipid bilayer;

FIG. 2 illustrates an example of a plurality of phospholipids forming a lipid bilayer structure;

FIG. 3 illustrates an example aqueous environment in which the lipids self-assembled into structures that minimize contact between water molecules and the hydrophobic components of the lipids by forming two leaflets (monolayers);

FIG. 4 illustrates a photograph of a quantity of an example ZVI encapsulated in a dry lipid (dry oleophilic/hydrophobic coating) referred to as dry coated ZVI; according to one embodiment;

FIG. 5 illustrates a microscope photograph of the example dry coated ZVI, according to one embodiment;

FIG. 6 illustrates a photograph of the example dry coated ZVI after it has been mixed in water, according to one embodiment;

FIGS. 7A-E illustrates microscope photographs of the example dry coated ZVI that has been placed in a water solution after 1-5 days respectively, according to one embodiment; and

FIGS. 8A-E illustrates microscope photographs of example dry coated ZVI that has been placed in a vegetable oil solution after 1-5 days respectively, according to one embodiment.

### DETAILED DESCRIPTION

A dry product to control the release rate of the zero-valent metal (e.g., ZVI) in the solution during remedial processes is proposed. A zero-valent metal product is encapsulated in a dry solution to control the release of the metal in the solution. The dry solution is an oleophilic/hydrophobic coating that is spray dried onto the surface of the ZVI particles. The oleophilic/hydrophobic coating may be liposomes, dendrimers or polymeric organic particles. The oleophilic/hydrophobic coating may be a powered vegetable oil. When mixed with water in the field, the oleophilic/hydrophobic coating creates a lipid bilayer around the ZVI to protect the ZVI from oxidation and passivation and thus control the release of the ZVI.

The dry coated ZVI allows for higher ZVI concentrations to be delivered to the subsurface than EZVI emulsions, reduces the manufacturing costs associated with producing a reverse emulsion, provides for a flexible material that may address both DNAPLs and dissolved chlorinated solvent plumes, allows for adsorption of dissolved phase chlorinated solvents into the oleophilic coating while protecting the ZVI surface during shipping and mixing in the field. One of the main benefits, of this approach is the ability to control the pH level of the targeted system by controlling the release of the ZVI material and preventing pH excursions.

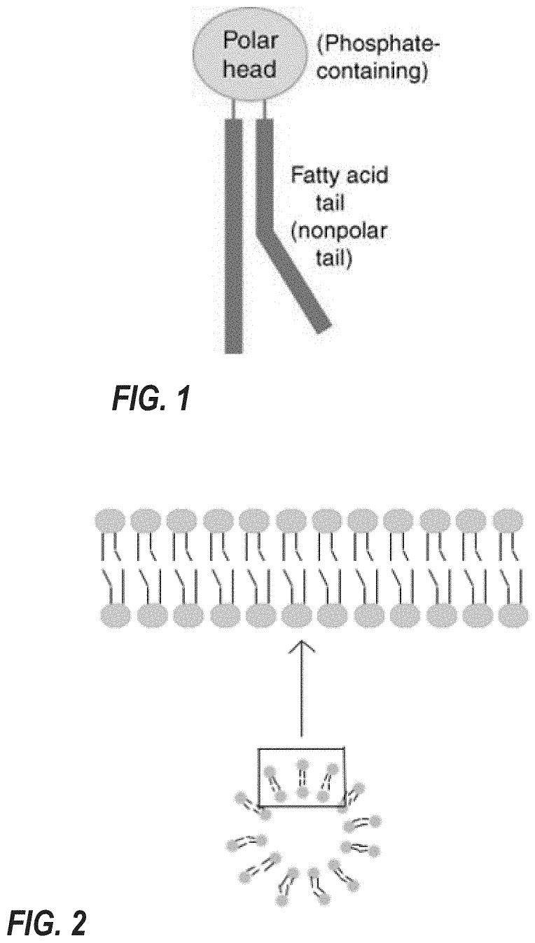

FIG. 1 illustrates an example phospholipid utilized for forming a lipid bilayer. Phospholipids (bilayer forming lipids) are amphipathic molecules that contain both hydrophilic and hydrophobic components. Each lipid molecule contains a hydrophilic region that is charged (called a polar head region) and a hydrophobic section that consists of a pair of alkyl chains, typically between 14 and 20 carbon atoms in length (called a nonpolar tail region). The phospholipid molecule's polar head group contains a phosphate group. The nonpolar tail region includes two fatty acid chain groups.

FIG. 2 illustrates an example lipid bilayer formed from phospholipids. The hydrophobic tails of each individual sheet interact with one another, forming a hydrophobic interior that acts as a permeability barrier. The hydrophilic head groups interact with the aqueous medium on both sides of the bilayer. The two opposing sheets are also known as leaflets.

The structure of the lipid bilayer explains its function as a barrier. Lipids are fats, like oil, that are insoluble in water. A lipid bilayer is a thin polar membrane composed of two layers of fatty acids organized in two sheets. The lipid bilayer is typically about five to ten nanometers thick and surrounds all cells providing the cell membrane structure. The lipid bilayer forms a continuous barrier around cells and thus provides a semipermeable interface between the interior and exterior of a cell and between compartments within the cell. The cell membrane of almost every living organism is made of a lipid bilayer, as are the membranes surrounding the cell nucleus and other sub-cellular structures. The lipid bilayer is the barrier that sustains ions, proteins and other molecules and prevents them from diffusing into areas where they should not be. Lipid bilayers are ideally suited to this role because, even though they are only a few nanometers in width, they are impermeable to most water-soluble (hydrophilic) molecules.

The phospholipids organize themselves in a bilayer to hide their hydrophobic tail regions and expose the hydrophilic regions to water. This organization is spontaneous, meaning it is a natural process and does not require energy. This structure forms the layer that is the wall between the inside and outside of the cell. Natural bilayers are usually composed of phospholipids. The phospholipid bilayer is the two-layer membrane that surrounds many types of plant and animal cells. It's made up of molecules called phospholipids which arrange themselves in two parallel layers, forming a membrane that can only be penetrated by certain types of substances. This gives the cell a clear boundary and keeps unwanted substances out. However, it can be damaged, and some types of unwanted substances can bypass it.

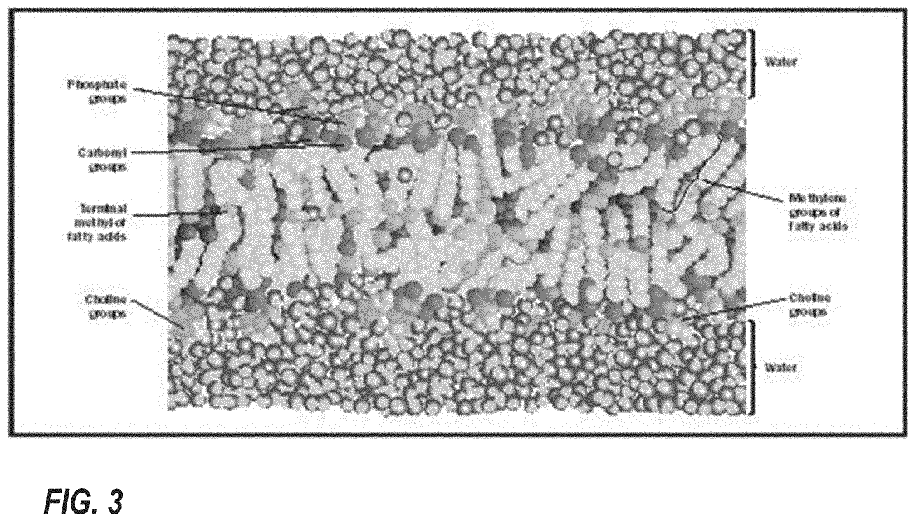

FIG. 3 illustrates an aqueous environment in which the lipids self-assemble into structures that minimize contact between water molecules and the hydrophobic components of the lipids by forming two leaflets (monolayers). This arrangement brings the hydrophobic tails of each leaflet in direct contact with each other and leaves the head groups in contact with water.

Among a wide variety of carriers, lipid-based systems present numerous advantages over other formulations. These carriers are biocompatible, biodegradable and are easily produced by versatile and up-scalable processes. Lipid-based systems have been used for the encapsulation of a wide variety of various agents, while controlling their kinetics of release. The internal physical state of lipid core nanoparticles has been shown to dramatically affect the encapsulation, while maintaining significant prolonged release rates.

The introduction of the traditional iron species in the subsurface often presents various challenges that include but are not limited to: a) the oxidation of the iron species, which results to the formation of numerous iron (II) and iron (III) species and can be observed by the rusting of iron over time during the presence of oxygen and groundwater; b) the rapid release of organic hydrogen into the solution that can be readily consumed, thus limiting the available amount for the dehalogenic bacteria, as the reaction process keeps ongoing and c) the rapid change of pH, which could result in an unfavorable environment for the microorganisms to operate.

The existence of the complicated structure of a potential lipid bi/multilayer electron donor, significantly enhances the release rates for the cations and anions in the solution as they are much slower compared to single layer electron donors. The encapsulated ZVI that is generated is hydrophobic, which allows the CVOCs to enter through a lipid membrane where it can diffuse to the ZVI particle and undergo degradation.

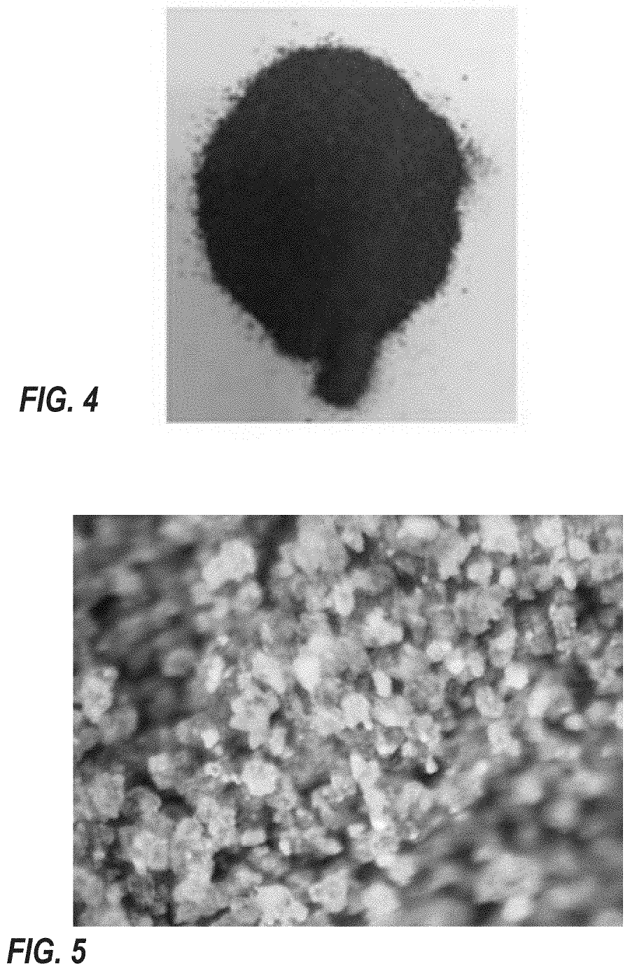

FIG. 4 illustrates an example of ZVI encapsulated in a dry lipid (dry oleophilic/hydrophobic coating) referred to as dry coated ZVI. FIG. 5 is a microscope photograph of the dry coated ZVI.

Simply coating the ZVI with the dry oleophilic/hydrophobic coating would result in a coated ZVI that floated on water. In order to have ZVI form a slurry when placed in water additional materials need to be included. For example, dispersing agents and thickening agents may be utilized within the dry formulation to overcome inherit challenges of mixing and introducing a hydrophobic material into an aqueous environment. Specifically, these agents would consist of between 0.2 to 2% by weight thickening agent and between 0.2 to 2% by weight emulsifying agent. The final dry product would therefore consist of approximately 20 to 60% by weight ZVI; approximately between 20 to 60% by weight of powdered vegetable oil or other polar lipid; 0.2 to 2% by weight guar or other thickening agent and 0.2 to 2% by weight lecithin or other dispersing agents.

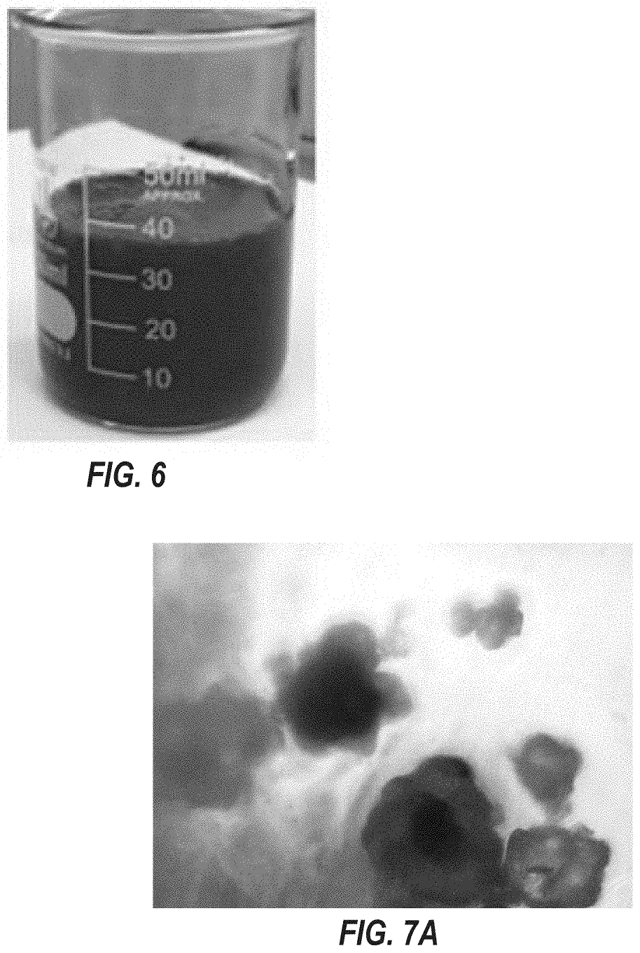

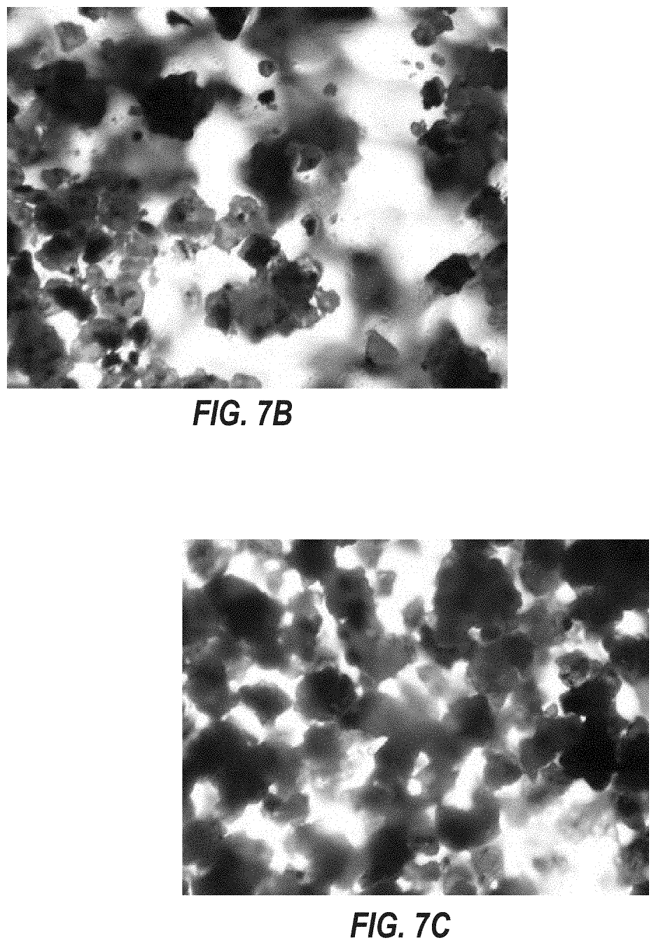

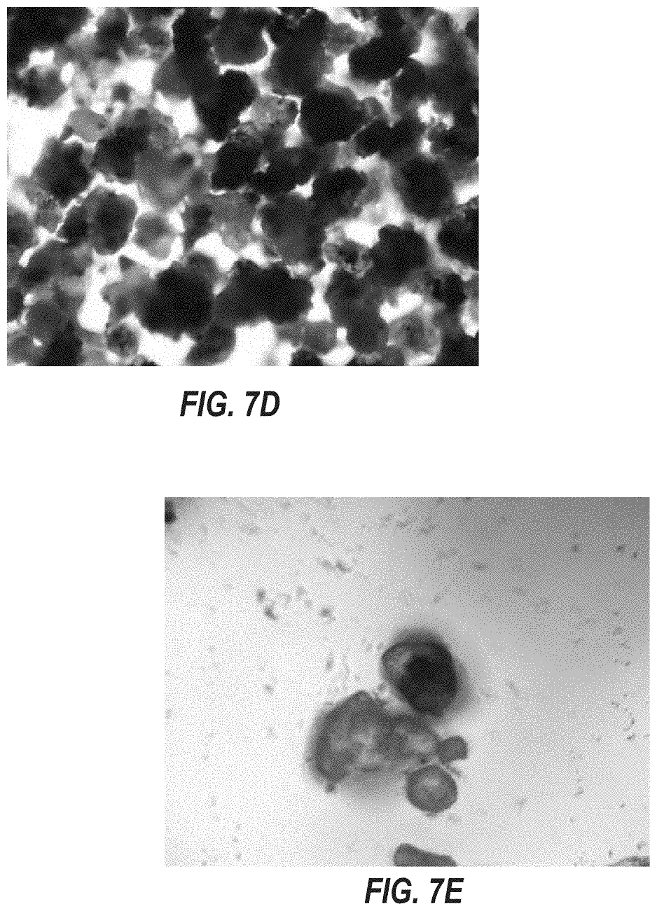

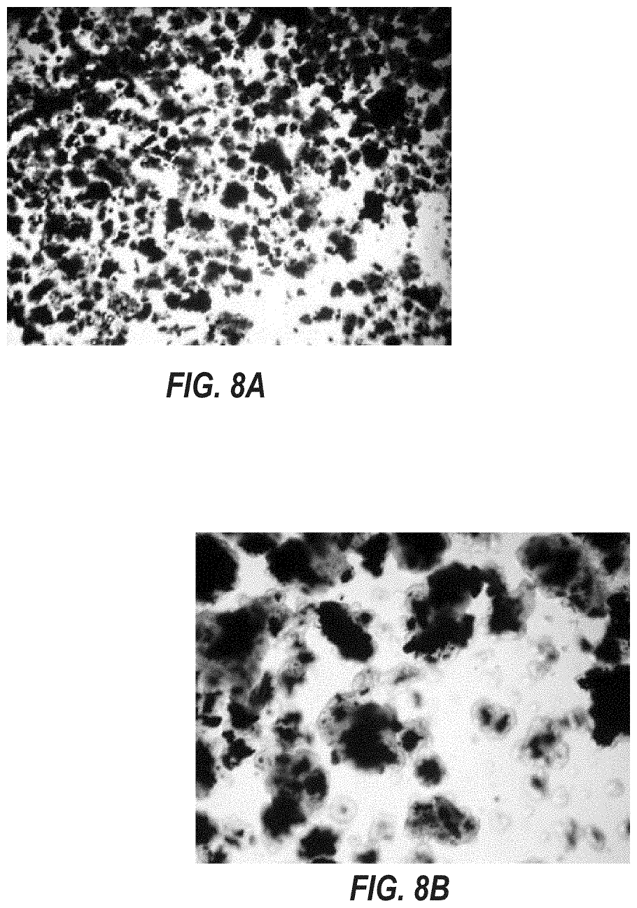

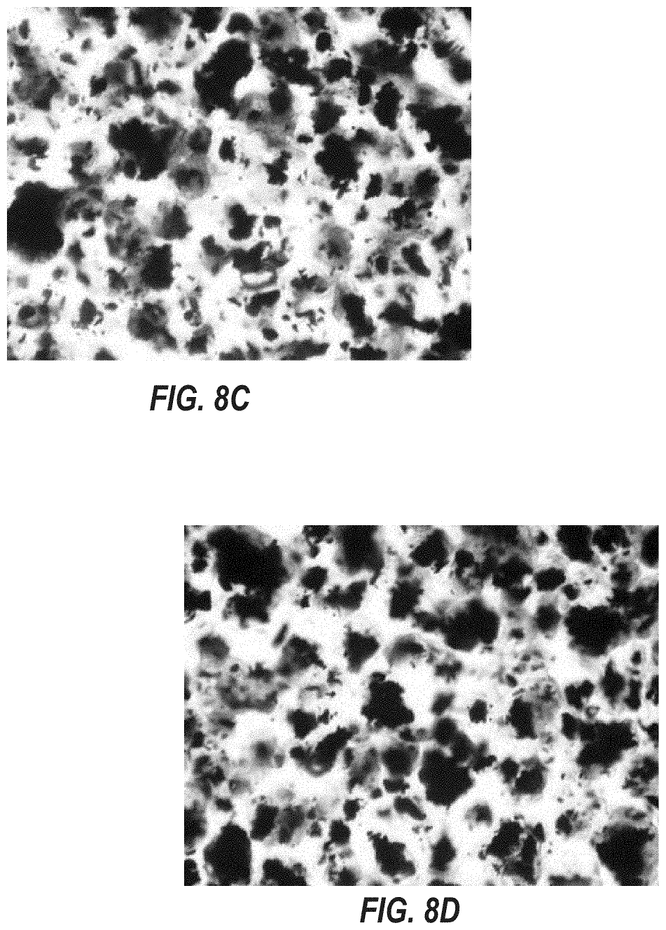

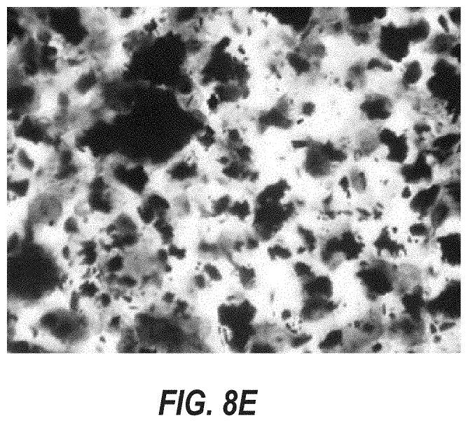

FIG. 6 illustrates the dry coated ZVI after it has been mixed in water. FIGS. 7A-E are photographs of the dry coated ZVI after being submerged in a water solution for 1-5 days. FIGS. 8A-E are photographs of the dry coated ZVI after being submerged in a vegetable oil solution for 1-5 days.

The microscope pictures clearly show the effective encapsulation of the ZVI particle by the lipid membrane for the dry sample and mixed in an aqueous solution. The ZVI still remained within the lipid structure 5 days after the mixing occurred.

The presence of a lipid multilayer compound can be utilized for in-situ reductive dechlorination (biotic remediation) in addition to the biotic remediation provide by the ZVI. The lipid multilayer compound proves to be very effective since it has the potential of lasting for a longer period of time in the environmental media under anaerobic conditions.

Further, the present invention may be applied to both DNAPLs and dissolved chlorinated solvent impacted sites by varying the ratio of water to the product when mixed, prior to delivery to the subsurface.

The dry product may be mixed with water prior to delivery to the subsurface at a ratio of between four (4) and six (6) pounds per gallon of water to obtain a material that has the specific gravity equal to or greater than the DNAPL of various chlorinated solvents, providing for a direct treatment of the free phase chlorinated product in the subsurface as well as impacted unsaturated soils above the water table entrained with chlorinated solvents. In a first phase, free phase chlorinated solvents are adsorbed into the oleophilic layer of the product followed by abiotic treatment by the core ZVI. In the second phase, the adsorbed chlorinated solvents in the soil matrix are desorbed into the oleophobic coating followed by treatment by the core ZVI particle.

The dry product may be mixed with between one half (½) to three (3) pounds per gallon of water to produce liquid material for the treatment of dissolved phase chlorinated solvents within the groundwater and adsorbed to the saturated soils. In this mixture the dissolved phase chlorinated solvent is adsorbed into the oleophobic layer of the product, allowing it to be degraded by the ZVI core.

Although the disclosures have been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A method for utilizing a controlled release zero-valent metal for in-situ remediation, the method comprising:
coating the zero valent metal with a dry mix including an oleophilic/hydrophobic layer to form a dry coated zero valent metal;
mixing the dry coated zero valent metal with water to form a slurry, wherein the introduction of the water creates a lipid membrane around the zero valent metal; and
introducing the slurry to a subsurface, wherein the liquid membrane controls release of zero-valent metal to groundwater.

2. The method of claim 1, wherein the dry mix includes a dispersing agent.

3. The method of claim 1, wherein the dry mix includes a thickening agent.

4. The method of claim 1, wherein the zero-valent metal is zero-valent iron.

5. The method of claim 1, wherein the oleophilic/hydrophobic layer includes liposomes.

6. The method of claim 1, wherein the oleophilic/hydrophobic layer includes dendrimers.

7. The method of claim 1, wherein the oleophilic/hydrophobic layer includes polymeric organic particles.

8. The method of claim 1, wherein the oleophilic/hydrophobic layer includes some combination of liposomes, dendrimers and polymeric organic particles.

9. The method of claim 1, further comprising the lipid membrane sorbing hydrophobic contaminants and osmotically reacting with organic compounds, thus leading to their biodegradation.

10. The method of claim 1, wherein the introducing includes introducing the slurry via temporary or permanent wells.

11. The method of claim 1, wherein the introducing includes introducing the slurry via gravity feeding, induced gas stream, a pump, or a combination thereof.

12. The method of claim 1, wherein the introducing includes introducing the slurry under pressure in either a gas or liquid stream.

13. The method of claim 1, further comprising providing additional materials known to promote a suitable environment for reductive dechlorination.

14. The method of claim 13, wherein the additional materials assist in introduction of organic hydrogen donors in the groundwater.

15. The method of claim 13, wherein the additional materials are biologically stimulating agents including vitamins, yeast extract, and biological cultures.

16. The method of claim 1, wherein the mixing includes mixing with an appropriate amount of water to obtain the slurry with a specific gravity equal to or greater than a dense non-aqueous phase liquid (DNAPL) of various chlorinated solvents.

17. The method of claim 16, wherein the dry coated zero valent metal is mixed with water at a ratio of between four (4) and six (6) pounds per gallon of water.

18. The method of claim 1, wherein the mixing includes mixing with an appropriate amount of water to obtain the slurry capable of treatment of dissolved phase chlorinated solvents within groundwater and adsorbed to saturated soils.

19. The method of claim 18, wherein the dry coated zero valent metal is mixed with water at a ratio of between one half (½) to three (3) pounds per gallon of water.

20. A method for utilizing a controlled release zero-valent iron (ZVI) for in-situ remediation, the method comprising:
coating the ZVI with a dry mix including an oleophilic/hydrophobic layer, a dispersing agent and a thickening agent to form a dry coated ZVI;
mixing the dry coated ZVI with an appropriate amount of water to form a slurry either having a specific gravity equal to or greater than a dense non-aqueous phase liquid (DNAPL) of various chlorinated solvents in order to treat the DNAPL or capable of treatment of dissolved phase chlorinated solvents within groundwater and adsorbed to saturated soils, wherein the introduction of the water creates a lipid membrane around the ZVI; and
introducing the slurry to a subsurface, wherein the liquid membrane controls release of ZVI to the groundwater.
